(19) United States
(12) Patent Application Publication
(10) Pub. No.: US 2019/0329716 A1
(43) Pub. Date: Oct. 31, 2019

(54) DISPLAY DEVICE

(71) Applicant: Panasonic Intellectual Property Management Co., Ltd., Osaka (JP)

(72) Inventors: KOSUKE KUBOTA, Osaka (JP); KEN'ICHI KASAZUMI, Osaka (JP); TOSHIYA MORI, Osaka (JP)

(21) Appl. No.: 16/508,280

(22) Filed: Jul. 10, 2019

Related U.S. Application Data
(63) Continuation of application No. PCT/JP2018/000603, filed on Jan. 12, 2018.

(30) Foreign Application Priority Data
Jan. 18, 2017 (JP) 2017-007124

(51) Int. Cl. B60R 11/02

(52) U.S. Cl. CPC B60R 11/0235; G02B 2027/0163

(57) ABSTRACT

A display device that displays a virtual image by projecting an image onto a display medium includes: a light source unit; a screen that is movably disposed on an optical path from the light source unit to the display medium; a self-emitting display unit that is disposed adjacent to the optical path; a scan unit that scans the screen with the light emitted from the light source unit; and a drive unit that moves the screen along the optical path. The screen is disposed to project an image imaged on the screen by scanning of the scan unit onto the display medium. The self-emitting display unit is disposed to project an image generated by the self-emitting display unit onto the display medium.

### TECHNICAL FIELD

The present disclosure relates to a display device.

### BACKGROUND ART

There has been known a head-up display (hereinafter, also abbreviated as HUD) directly reflecting information on a field of view of a human. The HUD is used in various fields such as automobile fields and airplane fields. In the case of being used in a vehicle such as automobile, the HUD displays various kinds of information on the conditions and traveling routes of a vehicle using images of numerals, characters, and graphics such as arrows, for example. Some of vehicle HUDs present virtual images formed in front of a windshield to a driver. For example, PTL 1 discloses a vehicle HUD apparatus that displays information such as driving information as a virtual image at a long distance via a windshield.

### CITATION LIST

### Patent Literature

PTL 1: Unexamined Japanese Patent Publication No. 2009-150947

### SUMMARY OF THE INVENTION

The present disclosure provides a display device that displays an image clearly.

A display device according to an aspect of the present disclosure is a display device that displays a virtual image by projecting an image onto a display medium and includes a light source unit, a screen, a self-emitting display unit, a scan unit, the screen, and a drive unit. The light source unit emits light. The screen is movably disposed on an optical path from the light source unit to the display medium. The self-emitting display unit is disposed adjacent to the optical path. The scan unit scans the screen with the light emitted from the light source unit. The drive unit moves the screen along the optical path. The screen is disposed to project an image imaged on the screen by scanning of the scan unit onto the display medium, and the self-emitting display unit is disposed to project an image generated by the self-emitting display unit onto the display medium.

It should be noted that the comprehensive or specific aspects above may be implemented by a system, a method, an integrated circuit, a computer program, or a recording medium such as a computer-readable CD-ROM, or may be implemented by any combination of a system, a method, an integrated circuit, a computer program, and a (non-transitory) recording medium.

According to the display device of the present disclosure, it is possible to display an image clearly.

### BRIEF DESCRIPTION OF DRAWINGS

FIG. 1 is a view illustrating an application example of a display device according to an exemplary embodiment to a vehicle.

FIG. 2 is a view illustrating an example of a region of an image displayed on a windshield by the display device illustrated in FIG. 1.

FIG. 3 is a view illustrating an example of an image displayed by the display device illustrated in FIG. 1.

FIG. 4 is a block diagram illustrating an example of a functional configuration of the display device according to the exemplary embodiment.

FIG. 5 is a diagram illustrating an example of a configuration in which the display device illustrated in FIG. 4 is mounted in a vehicle.

FIG. 6 is a diagram illustrating an example of positional relationships among a scan unit, a screen, and a self-emitting display unit in the display device illustrated in FIG. 4.

FIG. 7 is a view illustrating an example of a display image on the display device according to the exemplary embodiment, where an actually existing foreground seen through a windshield is removed from the display image illustrated in FIG. 3.

FIG. 8 is a diagram illustrating an example of light transmission characteristics of a reflecting mirror applied to an optical system in the display device according to the exemplary embodiment.

FIG. 9 is a diagram illustrating a modification of the self-emitting display unit in the display device according to the exemplary embodiment in the same manner as in FIG. 6.

FIG. 10 is a diagram illustrating another modification of the self-emitting display unit in the display device according to the exemplary embodiment in the same manner as in FIG. 6.

### DESCRIPTION OF EMBODIMENTS

### Findings of the Inventors of the Present Invention

The inventors of the present invention have achieved the following findings in relation to the technology described in the section of “BACKGROUND ART”. The vehicle HUD device described in PTL 1 forms information as a virtual image to be superimposed on the foreground in the forward field of view on the opposite side of the windshield as seen from a driver. The vehicle HUD device moves a screen scanned with scanning light for forming an image in an optical-axis direction, thereby to change a forming position of the virtual image. The forming position of the virtual image is located in a depth direction of the virtual image as seen from the driver, which is also called display distance of the virtual image. For example, the vehicle HUD device described in PTL 1 performs control to change the display distance of the virtual image according to a running speed of the vehicle to reduce movement of point of view of the driver during driving. Specifically, the display distance of the virtual image is made longer when the running speed of the vehicle is fast than when the running speed of the vehicle is slow.

The vehicle HUD device described in PTL 1 includes a plurality of screens for displaying a virtual image via the windshield. The plurality of screens is aligned and independently movable. The positions of the plurality of screens as seen in the optical-axis direction are different from one another so that the plurality of screens displays a plurality of virtual images different in display distance at the same time. The screens can move along the optical axis to change the display distances of the virtual images over time. Accordingly, the vehicle HUD device displays the virtual images of objects around the vehicle, for example, intersections where the vehicle is to turn, other vehicles, and obstacles, while changing the display distances along with the travel of the vehicle.

The display information requested by the HUD includes information generated according to the travel of the vehicle and information constantly displayed during the running of the vehicle. For example, the information generated according to the travel of the vehicle is temporarily displayed information such as the traveling direction of the vehicle, the distance to right or left turn, and a warning about an obstacle, the information being desirably superimposed on the foreground in the forward field of view of the driver. For example, the information constantly displayed during the running of the vehicle is information relating to the conditions of the vehicle such as the speed of the vehicle, the remaining fuel amount, water temperature, and oil temperature.

The information generated according to the travel of the vehicle as described above can be displayed as a virtual image that is located at a distance of about 10 to 200 m from the driver, that is, a long-distance virtual image. The distance from the driver to the long-distance virtual image desirably changes along with the travel of the vehicle. The information constantly displayed during the running of the vehicle can be displayed at a distance of about two to three meters from the driver, that is, a short-distance virtual image. The distance from the driver to the short-distance virtual image is desirably constant regardless of the travel of the vehicle.

However, in the vehicle HUD device described in PTL 1, all the plurality of screens is movable and thus the display distances of all the virtual images change. In particular, when the display distance of the information relating to the conditions of the vehicle changes, the driver has a difficulty in visually recognizing the information. For example, the driver may mistake the information relating to the conditions of the vehicle for information included in the foreground in the forward field of view.

Thus, the inventors of the present invention have contemplated using two screens, that is, a movable screen for forming a long-distance virtual image and a fixed screen for forming a short-distance virtual image. However, the distance between the driver and the screen necessary for forming a virtual image greatly varies between a case of a long-distance virtual image and a case of a short-distance virtual image. For example, the inventors of the present invention have found that, in order to obtain a clear virtual image in both the cases, there is a problem that the HUD needs to be increased in size to a degree that the HUD cannot be mounted in a vehicle. In addition, when the two screens are scanned with scanning light projected from one light source, the distances between the scan unit as a scanning light emission unit and the screens are greatly different, so that the spot diameter of the scanning light varies between the screens and the resolutions of the images formed on the screens are greatly different. Accordingly, the inventors of the present invention have found that configuration of the scan unit to minimize the spot diameter on the long-distance screen causes a problem that the spot diameter on the short-distance screen becomes large and the resolution of the short-distance virtual image becomes lower. In addition, the inventors of the present invention have found that scanning two screens with scanning light projected from one light source causes a problem that unnecessary light mixes into the virtual image or the virtual image becomes unclear due to influence of the scanning light leaking from between the two screens, or influence of the scanning light diffused at screen end faces between the two screens. The inventors of the present invention have found a technique for making an image to be displayed clear as described below.

A display device according to an aspect of the present disclosure is a display device that displays a virtual image by forming an image onto a display medium and includes a light source unit, a screen, a self-emitting display unit, a scan unit, the screen, and a drive unit. The light source unit emits light. The screen is movably disposed on an optical path from the light source unit to the display medium. The self-emitting display unit is disposed adjacent to the optical path. The scan unit scans the screen with the light emitted from the light source unit. The drive unit moves the screen along the optical path. The screen is disposed to project an image imaged on the screen by scanning of the scan unit onto the display medium, and the self-emitting display unit is disposed to project an image generated by the self-emitting display unit onto the display medium.

According to the foregoing aspect, two images projected from the screen and the self-emitting display unit onto the display medium are reflected on the display medium and arrive at the eyes of a person viewing the display medium. At this time, the person visually recognizes two virtual images of the two images on an opposite side of the display medium. Each of display distances of the two virtual images depends on a distance along an optical path from the display medium to the screen and a distance along an optical path from the display medium to the self-emitting display unit. The screen and the self-emitting display unit do not affect quality of images generated by the screen and the self-emitting display unit. Accordingly, it is possible to obtain two clear virtual images by positioning the screen and the self-emitting display unit so as to match respective display distances required for the two virtual images. The scan unit does not need to scan the self-emitting display unit but needs to scan only the screen, so that it is possible to shallow a focal depth of a light beam emitted from the scan unit. Accordingly, a spot diameter of the light on the screen becomes small, so that it is possible to improve the resolution of the virtual image.

In the display device according to an aspect of the present disclosure, the screen and the self-emitting display unit may be disposed to partially overlap each other as seen from a direction along the optical path. According to the foregoing aspect, it is possible to reduce a gap between the image projected from the screen and the image projected from the self-emitting display unit. This reduces leakage of the scanning light from the scan unit through the gap.

In the display device according to an aspect of the present disclosure, the scan unit may be disposed such that the spot diameter becomes minimum at an almost center position in a movement range of the screen. According to the foregoing aspect, a maximum spot diameter in the movement range of the screen can be decreased, so that the spot diameter of the light on the screen becomes small, and accordingly, the resolution of the image is enhanced. This achieves improvement in the resolution of the virtual image.

In the display device according to an aspect of the present disclosure, an image projected from the screen onto the display medium and an image projected from the self-emitting display unit onto the display medium may be adjacent to each other. According to the foregoing aspect, it is possible to decrease eye movement for visually recognizing a virtual image of the image projected from the screen and a virtual image of the image projected from the self-emitting display unit. This makes it easy to visually recognize the two virtual images.

The display device according to an aspect of the present disclosure may further include an optical system that is disposed on the optical path between the screen and the display medium. The optical system may project the image projected from the screen onto the display medium in a changed projection direction. According to the foregoing aspect, it is possible to increase the display distance of the virtual image corresponding to the distance from the display medium to the screen along the optical path while suppressing upsizing of the display device.

The display device according to an aspect of the present disclosure may be mounted on a movable body, an image imaged on the screen may be an image temporarily displayed along with travel of the movable body, and an image generated by the self-emitting display unit may be an image continuously displayed. According to the foregoing aspect, a display distance of a virtual image of the image continuously generated by the self-emitting display unit remains unchanged, which facilitates adjustment of eye focus for visually recognizing the virtual image continuously displayed, thereby making it easy to visually recognize the virtual image. A virtual image of the image imaged on the movable screen can be three-dimensionally represented with depth, for example. This makes it possible to form and display a three-dimensional virtual image along with the travel of the movable body. Such a virtual image is suitable for superimposition on the foreground in a traveling direction of the movable body.

In the display device according to an aspect of the present disclosure, the self-emitting display unit may be a flat panel display. The self-emitting display unit may have a light-guiding member that is disposed on a side opposite to a display surface of an image and a light source that projects light onto an edge of the light-guiding member. According to the foregoing aspect, it is possible to reduce an occupied space on a rear side of a display surface of the self-emitting display unit. This suppresses interference between constituent elements on the rear side of the self-emitting display unit and the screen in motion. Further, it is possible to decrease the distance between the self-emitting display unit and the screen, thereby achieving downsizing of the display device.

It should be noted that the comprehensive or specific aspects of the display device may be implemented by a system, a method, an integrated circuit, a computer program, or a recording medium such as a computer-readable CD-ROM, or may be implemented by any combination of a system, a method, an integrated circuit, a computer program, and a recording medium.

Hereinafter, a display device according to exemplary embodiment will be described with reference to the drawings. It should be noted that the display device according to the exemplary embodiment, which will be described below, provides comprehensive or specific examples of the present invention. Numerical values, shapes, materials, constituent elements, arrangement positions and connection modes of the constituent elements, steps, order of the steps, and the like illustrated in the following exemplary embodiment are merely examples, and therefore are not intended to limit the present disclosure. Among the constituent elements in the exemplary embodiment described below, constituent elements which are not described in the independent claims showing the top level concept are described as arbitrary constituent elements.

### Exemplary Embodiment

### [1-1. Schematic Configuration of Display Device According to Exemplary Embodiment]

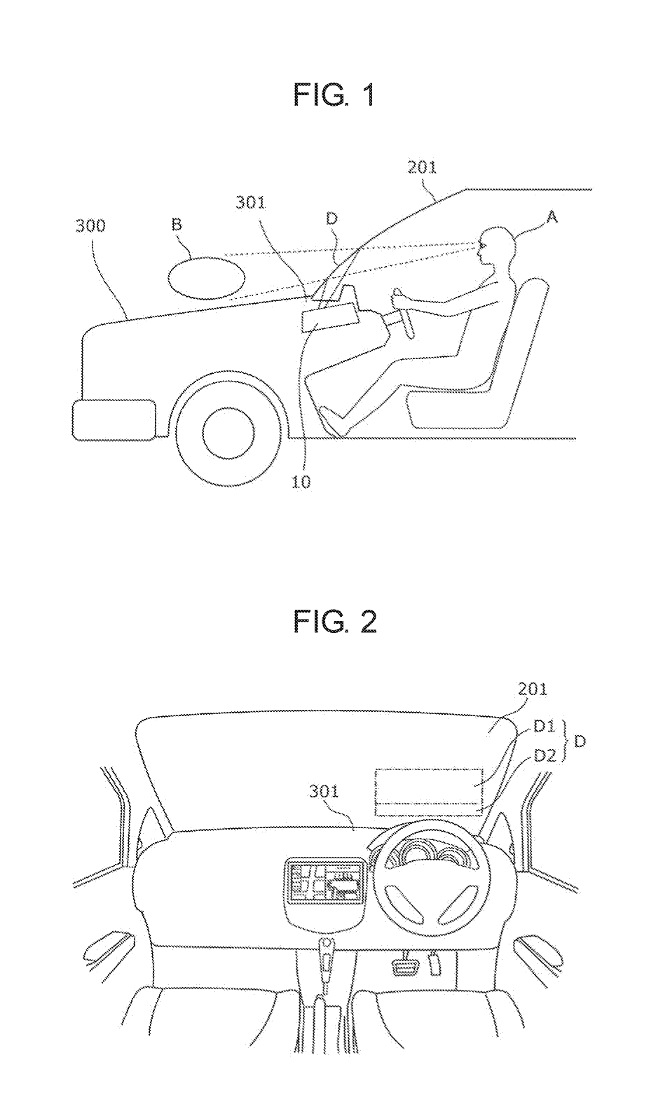

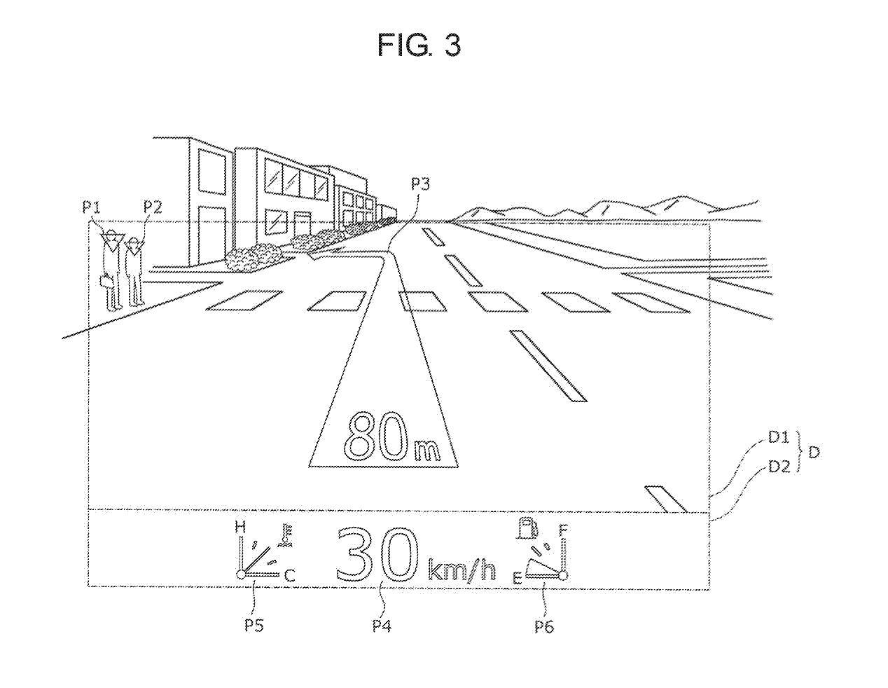

A schematic configuration of display device 10 according to an exemplary embodiment will be described with reference to FIGS. 1 to 3. In the exemplary embodiment described below, display device 10 is mounted as a head-up display (HUD) on vehicle 300 as an example of a movable body. However, display device 10 is not limited to be mounted on a vehicle. FIG. 1 is a view illustrating an application example of display device 10 according to the exemplary embodiment to vehicle 300. FIG. 2 is a view illustrating an example of a region of an image displayed on windshield 201 by display device 10 illustrated in FIG. 1. FIG. 3 is a view illustrating an example of an image displayed by display device 10 illustrated in FIG. 1.

As illustrated in FIG. 1, display device 10 according to the exemplary embodiment is provided as an HUD for vehicle, and is attached to vehicle 300 under windshield 201, specifically, near an upper surface of dashboard 301. In the present exemplary embodiment, windshield 201 is front windshield glass but may be windshield glass at any other portion.

As illustrated in FIGS. 1 and 2, display device 10 is configured to project light for forming virtual image B onto region D of windshield 201 as a display medium. The projected light is reflected on windshield 201 and travels toward face of driver A in vehicle 300, and is visually recognized by driver A. Driver A is a user of display device 10 who sits at a driver's seat of vehicle 300. A light beam visually recognized by driver A includes various light beams different in a distance between a light emitting position and driver A. Driver A captures an image formed by the visually recognized light as three-dimensional virtual image B including portions different in distance from driver A. Driver A captures virtual image B as an image existing outside the vehicle opposite to windshield 201 with a foreground of a forward field of view seen through windshield 201, that is, an actually existing object, as a background. In the following description, a situation in which display device 10 projects light onto windshield 201 and driver A visually recognizes virtual image B may be expressed as display device 10 displaying virtual image B with windshield 201. The display medium of display device 10 is not limited to windshield 201 but may be any other display medium on which the user can visually recognize the light projected by display device 10 and reflected.

Referring to FIGS. 1 to 3, display device 10 projects light onto region D that is a region surrounded by an alternate long and short dash line on windshield 201, for example. The region D is located at a lower part in front of driver A on windshield 201. Driver A sitting at the driver's seat visually recognizes an image formed by light projected onto region D as virtual image B outside the vehicle opposite to windshield 201. In the present exemplary embodiment, virtual image B may be formed as an image based on perspective. Such virtual image B appears closer to driver A as being at a lower position in region D, and appears more distant from driver A as being at a higher position in region D.

FIG. 3 illustrates an example in which the foreground of the forward field of view of vehicle 300 and virtual image B displayed by display device 10 are superimposed as seen from driver A in vehicle 300 during running. FIG. 3 illustrates images in region D visually recognized by driver A and near region D. Display device 10 displays different images in region D1 and region D2 obtained by longitudinally halving region D. Region D1 is positioned above region D2. Display device 10 displays a first virtual image in region D1 and displays a second virtual image in region D2. In the present exemplary embodiment, display device 10 displays a virtual image according to perspective in region D1. This virtual image varies in the distance of the virtual image visually recognized by driver A according to the longitudinal position in region D1 as described above. Display device 10 displays a virtual image at a constant distance visually recognized by driver A in region D2 regardless of the position in region D2.

For example, display device 10 displays in region D1 the first virtual image with a change in the display distance according to travel of vehicle 300. The first virtual image includes an intersection to be turned, a distance to the intersection, a direction of right or left turn, a direction to be traveled or a lane, other vehicles, obstacles, and others. A temporary image can be displayed as a virtual image in region D1. Display device 10 also displays in region D2 the second virtual image as information about the conditions of the vehicle in a constant state regardless of the travel of vehicle 300, for example, without changing shape, dimensions, and position. Information to be constantly displayed during running of the vehicle is displayed in region D2, and the information can be constantly displayed in region D2.

### 1-2. Configuration of Display Device According to Exemplary Embodiment

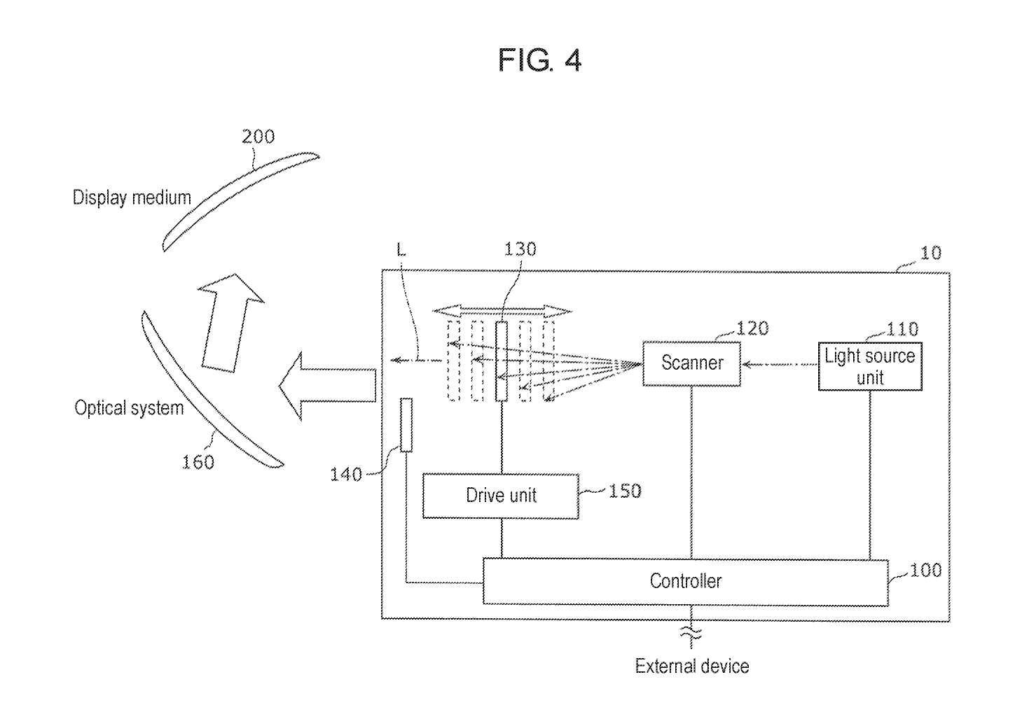

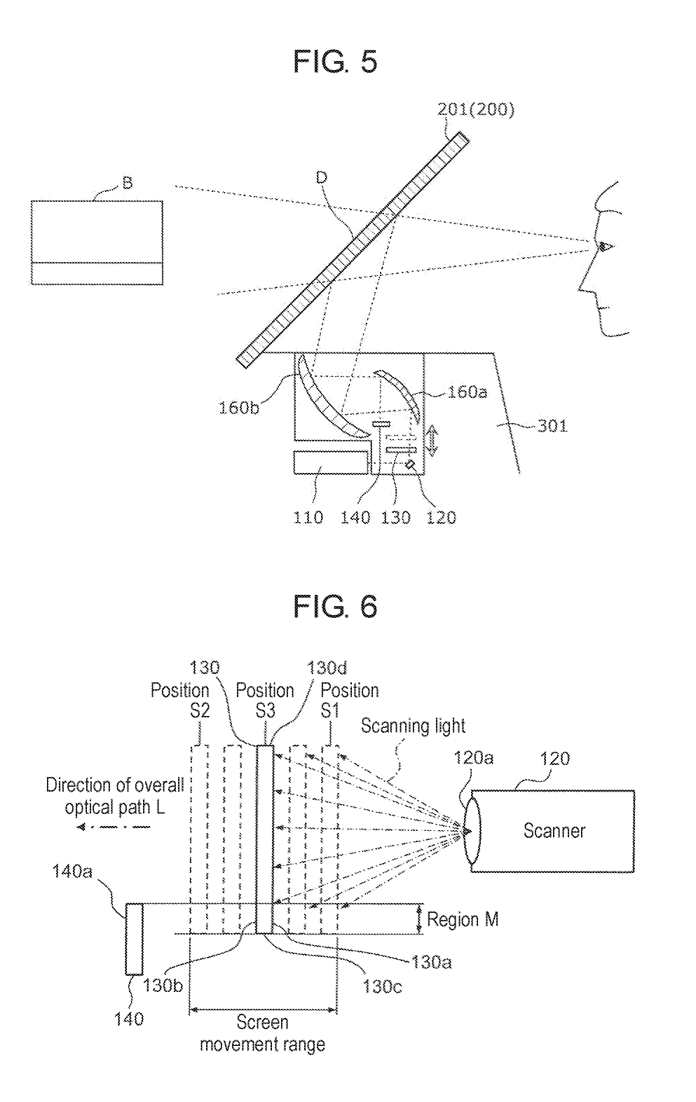

A detailed configuration of display device 10 according to the exemplary embodiment will be described with reference to FIGS. 4 to 6. FIG. 4 is a block diagram illustrating an example of a functional configuration of display device 10 according to the exemplary embodiment. FIG. 5 is a diagram illustrating an example of a configuration of display device 10 illustrated in FIG. 4 that is mounted in vehicle 300. FIG. 6 is a diagram illustrating an example of positional relationships among scan unit (scanner) 120, screen 130, and self-emitting display unit (self-emitting display) 140 in display device 10 illustrated in FIG. 4.

Referring to FIGS. 4 and 5, display device 10 includes light source unit (light source) 110, scan unit 120, screen 130, self-emitting display unit 140, drive unit (driver) 150, and controller 100. In FIG. 4, arrows of alternate long and short dash lines starting from light source unit 110 indicate individual optical paths in display device 10. Specifically, the arrows of alternate long and short dash lines indicate an optical path of projection light from light source unit 110 to scan unit 120 and individual optical paths from scan unit 120 to screen 130.

Light source unit 110 emits light for forming a virtual image. The light emitted from light source unit 110 is projected onto windshield 201, that is, display medium 200, thereby to form a virtual image visually recognizable by driver A. For example, light source unit 110 is configured by a projector that includes semiconductor laser light sources that emit red (R), green (G), and blue (B) light as light emitting bodies. This projector enables formation of a highly recognizable virtual image regardless of objects around vehicle 300, body color of vehicle 300, and brightness of surroundings of vehicle 300. Display device 10 including the semiconductor laser light sources enables a compact configuration, so that it is possible to minimize a space of dashboard 301 occupied by display device 10.

Scanner 120 is arranged on the optical path of light emitted from light source unit 110. Scanner 120 emits the light received from light source unit 110 as scanning light onto screen 130 to scan screen 130 with the scanning light. Scanner 120 can emit the light received as scanning light in an arbitrary direction, which is implemented by a micro electro mechanical systems (MEMS) mirror, for example. The scanning light from scan unit 120 images an image to be displayed as a virtual image on screen 130. The scanning of screen 130 by scan unit 120 may be two-dimensional scanning, for example, raster scanning by which horizontal scanning is gradually shifted to a vertical direction.

In the present exemplary embodiment, screen 130 is a rectangular plate-, sheet-, or film-shaped member, but the shape of screen 130 is not limited to the foregoing ones. Screen 130 is configured such that light having arrived at screen 130 can form an image on screen 130. In the present exemplary embodiment, screen 130 is configured by a light-transmissible member but may be configured by a light-reflecting member. Screen 130 capable of light transmission is configured by a semi-transparent member, for example. Screen 130 may be a diffusing screen, for example. Screen 130 projects onto optical system 160 the image imaged by the scanning light from scan unit 120 on screen 130.

Screen 130 is disposed within an irradiation range of the scanning light from scan unit 120, that is, a scanning range. Screen 130 can reciprocate in parallel along overall optical path L of the scanning light as shown by a void arrow in FIG. 4. Screen 130 oscillates back and forth, for example. The “overall optical path L” here includes an optical path formed by overall light traveling from light source unit 110 to optical system 160 and also includes an overall optical path of light traveling from light source unit 110 through scan unit 120, screen 130, optical system 160, and others to driver A in vehicle 300. In the following description, the “overall optical path” may be called simply “optical path”.

Drive unit 150 causes screen 130 to reciprocate in parallel to the direction described above according to a signal from controller 100 described later. Drive unit 150 is configured by an electromagnetic, hydraulic, or ultrasonic actuator, for example.

Self-emitting display unit 140 emits light by itself to display an image. Self-emitting display unit 140 includes a display, for example. Specifically, self-emitting display unit 140 may be a liquid crystal display (LCD) or a flat panel display (FPD) such as an organic or inorganic electro luminescence (EL) display. Self-emitting display unit 140 displays information to be displayed such as information indicating the conditions of vehicle 300 according to the signal from controller 100. A display surface of self-emitting display unit 140 is directed to optical system 160. A display image on self-emitting display unit 140 is projected onto display medium 200 via optical system 160.

Optical system 160 projects onto region D of windshield 201 as display medium 200 the images projected by screen 130 and self-emitting display unit 140 onto optical system 160. Optical system 160 may include a reflecting mirror that reflects light, a lens that enlarges or contracts light to be transmitted, and the like. In the present exemplary embodiment, optical system 160 includes a reflecting mirror such as a concave mirror or a plane mirror. Specifically, optical system 160 includes two reflecting mirrors 160a and 160b as illustrated in FIG. 5. Reflecting mirrors 160a and 160b may be small-sized reflecting mirrors that are stored in a housing not illustrated of display device 10 in a small size. Reflecting mirrors 160a and 160b are opposed to each other. In the present exemplary embodiment, both reflecting mirrors 160a and 160b are concave mirrors. However, either one or both of the reflecting mirrors may be a plane mirror or a convex mirror.

An image on screen 130 and an image on self-emitting display unit 140 are projected onto first reflecting mirror 160a. Each of the images is reflected and enlarged by first reflecting mirror 160a, and is projected onto second reflecting mirror 160b. Each of the images is further reflected and enlarged again by second reflecting mirror 160b, and is projected onto display medium 200. Use of reflecting mirrors 160a and 160b allows the images to be projected onto desired directions in an enlarged state. Display medium 200 as windshield 201 forms a curved display surface. However, use of reflecting mirrors 160a and 160b as curved mirrors makes it possible to adjust a distortion of an image projected onto the display surface. An orientation of an image after reflection on the concave mirror can change 180° with respect to the image before reflection. However, use of two reflecting mirrors 160a and 160b makes it possible to suppress a change in the orientation of an image caused by the reflection. Optical system 160 may include a lens, and the lens may enlarge an image and adjust an orientation of the image. All or some components of optical system 160 may be included in display device 10 as constituent elements.

Controller 100 controls entire display device 10. For example, controller 100 acquires information from an external device, and calculates an image to be displayed as a virtual image and a position of the image based on the acquired information. The external device may be a car navigation system, a speed meter, a water temperature meter, a human body detector, an eye location detector, an obstacle detector, or the like mounted in a vehicle, for example. Controller 100 outputs information indicating calculation results as a signal to light source unit 110 to control light emission of light source unit 110. Controller 100 also outputs control signals to scan unit 120 and drive unit 150 to control operations of scan unit 120 and screen 130. Based on the information acquired from the external device, controller 100 causes self-emitting display unit 140 to display information to be displayed. Controls of light source unit 110, scan unit 120, drive unit 150, and self-emitting display unit 140 may be independently performed but may include adjustments of synchronization among these components, and the like. Controller 100 may be configured by a computer system (not illustrated) including a central processing unit (CPU), a random access memory (RAM), a read-only memory (ROM), and others. All or some of functions of controller 100 may be implemented by execution of programs recorded on the ROM by the CPU using the RAM as a working memory. In addition, all or some of the functions of controller 100 may be implemented by a dedicated hardware circuit. Controller 100 may be configured by a single constituent element that performs a centralized control, or may be configured by a plurality of constituent elements performing a decentralized control in cooperation. In the present exemplary embodiment, controller 100 is a constituent element of display device 10 but may be a constituent element of the external device.

In display device 10 configured as described above, an image imaged by the scanning light on screen 130 and an image displayed by self-emitting display unit 140 are projected onto optical system 160, and the projected images are changed in orientation and enlarged by optical system 160 and projected onto windshield 201 as display medium 200. The image imaged on screen 130 is projected onto region D1 in windshield 201 illustrated in FIG. 3, and the image on self-emitting display unit 140 is projected onto region D2 in windshield 201 illustrated in FIG. 3. In the present exemplary embodiment, display medium 200 corresponds to windshield 201 on a front side of vehicle 300, but may be a windshield at any other position in vehicle 300 or may be any other portion.

FIG. 6 illustrates positional relationships among scan unit 120, screen 130, and self-emitting display unit 140. Scanner 120 includes lens 120a. Lens 120a may be a convex lens. Scanner 120 emits the light received from light source unit 110 as scanning light via lens 120a. Screen 130 has first main surface 130a forming a light-receiving surface opposed to lens 120a. Specifically, first main surface 130a of screen 130 is positioned in front of lens 120a. Screen 130 is reciprocable in parallel to a direction moving closer to lens 120a and a direction moving away from lens 120a. That is, screen 130 is reciprocable within a predetermined movement range along overall optical path L from scan unit 120 toward first reflecting mirror 160a (see FIG. 5), and light-receiving surface 130a of screen 130 is almost perpendicular to overall optical path L.

A beam diameter of the scanning light emitted from lens 120a gradually becomes small with decreasing proximity to lens 120a, then becomes minimum at a beam waist, and then gradually becomes large. In the present exemplary embodiment, although not limited, scan unit 120 is disposed with respect to screen 130 such that the beam waist of the scanning light is positioned in an almost middle, that is, in a center of the predetermined movement range of screen 130 as seen in overall optical path L. Accordingly, when screen 130 is located at position S1 nearest scan unit 120 and is located at position S2 farthest from scan unit 120, a spot diameter of the scanning light on screen 130 becomes maximum. When screen 130 is located at middle position S3 between position S1 and position S2 within the predetermined movement range, the spot diameter of the scanning light on screen 130 becomes minimum. When screen 130 is positioned within the predetermined movement range, a focal depth of the scanning light may be shallow, which suppresses a maximum spot diameter of the scanning light.

Self-emitting display unit 140 in a plate shape is adjacent to overall optical path L. Self-emitting display unit 140 is positioned along overall optical path L. Further, self-emitting display unit 140 is positioned more distant from scan unit 120 than screen 130 along overall optical path L, that is, in proximity to first reflecting mirror 160a. Accordingly, in overall optical path L, self-emitting display unit 140 is positioned nearer the eyes of driver A than screen 130. Self-emitting display unit 140 has display surface 140a oriented toward first reflecting mirror 160a. Self-emitting display unit 140 is partially opposed to second main surface 130b of screen 130. Second main surface 130b is a surface of screen 130 opposite to first main surface 130a. In the present exemplary embodiment, although not limited, self-emitting display unit 140 is disposed approximately parallel to screen 130. When screen 130 is seen from scan unit 120 along overall optical path L, edge 130c as a portion of a peripheral edge of screen 130 and area M adjacent to edge 130c of screen 130 overlap self-emitting display unit 140. When screen 130 is seen from scan unit 120 along overall optical path L, edge 130c constitutes a peripheral edge of screen 130 adjacent to self-emitting display unit 140.

Scanner 120 can scan entire first main surface 130a of screen 130 by arbitrarily changing the direction of the scanning light. Screen 130 and self-emitting display unit 140 overlap each other in area M, which suppresses the scanning light from leaking from edge 130c between screen 130 and self-emitting display unit 140 and reaching first reflecting mirror 160a. In addition, this suppresses the scanning light from diffusing from edge 130c and reaching first reflecting mirror 160a.

In scan unit 120 of the present exemplary embodiment, the focal depth of the scanning light emitted from lens 120a corresponds to a movement distance of screen 130 between positions S1 and S2. For example, when self-emitting display unit 140 is a screen as well, the focal depth of the scanning light corresponds to a distance between screen 130 at position S1 and the screen in place of self-emitting display unit 140. In the latter case, the focal depth of the scanning light becomes large, and thus the spot diameter of the scanning light on the screen in place of self-emitting display unit 140 increases to deteriorate resolution of the image. In the present exemplary embodiment, scan unit 120 scans only screen 130, and therefore disposition of scan unit 120 and screen 130 to be scanned can be determined such that spot diameters of all the light become optimum.

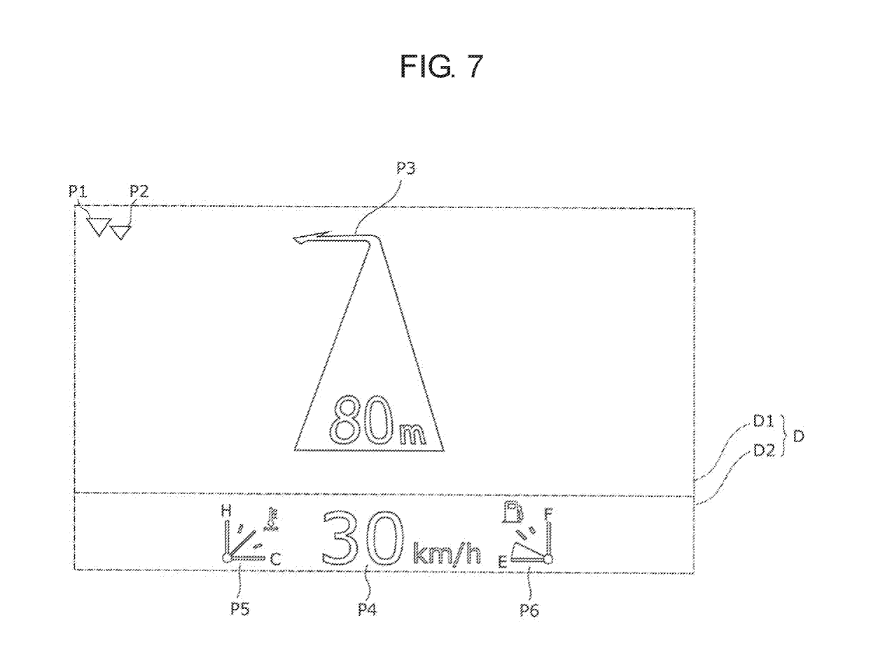

The images on screen 130 and self-emitting display unit 140 that partially overlap each other as described above are respectively displayed in regions D1 and D2 on windshield 201 as illustrated in FIG. 7. FIG. 7 is a view illustrating an example of a display image on display device 10 according to the exemplary embodiment, where an actually existing foreground seen through windshield 201 is removed from the display image illustrated in FIG. 3. Driver A seeing windshield 201 sees images displayed in regions D1 and D2 as virtual images. Self-emitting display unit 140 is positioned nearer driver A than screen 130 along overall optical path L, so that driver A visually recognizes that the virtual image in region D2 is nearer than the virtual image in region D1. A boundary between region D1 and region D2 corresponds to an overlapping portion between screen 130 and self-emitting display unit 140. At the boundary between region D1 and region D2, region D1 and region D2 are adjacent to each other without a gap. This suppresses occurrence of a glare that could be formed by the scanning light leaking from between screen 130 and self-emitting display unit 140 and suppresses deterioration in a contrast of the virtual image caused by diffusion of the scanning light at edge 130c of screen 130.

Referring to FIGS. 3 and 7, display device 10 displays images P1 to P3 in region D1, for example, and displays images P4 and P5 in region D2, for example. Images P1 and P2 are images in which pedestrians in front of vehicle 300 and detected by vehicle 300 are highlighted. Image P3 is an image of a traveling route of vehicle 300, which includes an arrow indicating a direction of right or left turn and a distance to a point of the right or left turn, for example. In an example of FIG. 7, image P3 indicates that a left-turn point is 80 m ahead. Images P4 to P6 are images respectively indicating a running speed of vehicle 300, a temperature of cooling water, and a remaining amount of fuel. Self-emitting display unit 140 displays images indicating the running speed, the temperature of cooling water, and the remaining amount of fuel based on signals received from a speed sensor, a water temperature sensor, and a fuel sensor of vehicle 300.

Images P1 and P2 are formed as described below, for example. A human body detector (not illustrated) mounted in vehicle 300 detects a person existing in a range of a constant distance from vehicle 300, and acquires information on a position of the person. Various known methods such as using a camera or millimeter-wave radar, for example, are applicable to the detection of a person and the acquisition of information on the position of the person. Further, an eye location detector (not illustrated) mounted in vehicle 300 detects motion of the eyes of driver A and acquires information on line of sight. Various known methods such as using a camera or infrared rays, for example, are applicable to the detection of motion of the eyes of driver A and the acquisition of the information on the line of sight. Based on results of detection by the human body detector and the eye location detector, display device 10 calculates positions of images P1 and P2 such that the virtual images of images P1 and P2 overlap the pedestrians, and displays images P1 and P2 at the positions.

Image P3 is formed as described below, for example. A car navigation system (not illustrated) mounted in vehicle 300 determines a route to an input destination. Then, based on information on a decided path, the car navigation system determines guidance information to be displayed relating to the traveling route along with the travel of vehicle 300. Further, the eye location detector detects motion of the eyes of driver A and acquires information on the line of sight. Based on the guidance information and the results of the detection by the eye location detector, display device 10 calculates a position of image P3 such that the virtual image of image P3 is visually recognized to overlap the left-turn point or in front of the left-turn point, and displays image P3 at that position. Image P3 is three-dimensionally formed such that the virtual image has a depth in the traveling direction of vehicle 300, that is, such that the display distance of the virtual image increases continuously.

Hereinafter, an image generation operation by scan unit 120 and screen 130 will be described. Referring to FIG. 6, screen 130 moves along overall optical path L within a predetermined movement range along overall optical path L. Screen 130 can change a distance between screen 130 and display medium 200 along overall optical path L. When the distance between screen 130 and display medium 200 becomes short, a display distance of a virtual image of the image projected onto display medium 200 also becomes short. That is, driver A visually recognizes the virtual image more nearby. On the other hand, when the distance between screen 130 and display medium 200 becomes long, the display distance of the virtual image of the image projected onto display medium 200 also becomes long. That is, driver A visually recognizes the virtual image farther.

While screen 130 reciprocates within the predetermined movement range, scan unit 120 projects the scanning light to image an image on screen 130. When the thus formed image is projected onto display medium 200, the virtual image of the projected image is visually recognized by driver A as a virtual image varying in display distance among portions. For example, when screen 130 is located within the predetermined movement range at position S1 most distant from display medium 200 along overall optical path L, scan unit 120 scans screen 130 near edge 130d with scanning light along edge 130d. Edge 130d is an edge opposite to edge 130c and self-emitting display unit 140. Position S2 of screen 130 is a position nearest display medium 200 along overall optical path L within the predetermined movement range. As screen 130 comes closer to display medium 200 along overall optical path L, screen 130 scans edge 130d in a direction along edge 130d while bringing the scanning position closer to edge 130c. The thus imaged image is projected onto region D1 of display medium 200. The projected image is visually recognized by driver A as a virtual image of which the display distance becomes long from downward to upward in a direction from region D2 to region D1.

Although not limited, in the present exemplary embodiment, screen 130 is reciprocated and vibrated at a high speed along overall optical path L between positions S1 and S2. At that time, screen 130 vibrates at a frequency of 60 Hz, for example. Scanner 120 also scans screen 130 at a high speed along with movement of screen 130. In a period during which screen 130 is making an outward movement from position S1 to position S2, scan unit 120 scans screen 130 from edge 130d to edge 130c. In a period during which screen 130 is making a return movement from position S2 to position S1, scan unit 120 scans screen 130 from edge 130c to edge 130d. Accordingly, a one-frame image is imaged on screen 130 by each of the outward movement and the return movement. Then, video of the virtual images changing in display distance is displayed by images of 120 frames formed per second.

For example, image P3 illustrated in FIGS. 3 and 7 is formed from an image imaged in the outward movement of screen 130 and an image imaged in the return movement of screen 130. In the outward movement, the scanning position is moved in a direction corresponding to the direction from region D1 to region D2 to image an image. In the return movement, the scanning position is moved in a direction corresponding to the direction from region D2 to region D1 to image an image. Image P3 is visually recognized by driver A as a three-dimensional virtual image that appears to be at shorter to longer distances along with the movement from a lower part to an upper part. That is, the arrow of image P3 is displayed as a virtual image that continuously changes in display distance in a three-dimensional space. By adjusting timing for imaging an image on screen 130, the display distance of the virtual image of the arrow may be temporally changed as vehicle 300 comes closer to the left-turn point indicated by the arrow of image P3. That is, the position of screen 130 to be scanned may be adjusted between positions S1 and S2 according to the distance between vehicle 300 and the arrow. The position of screen 130 to be scanned may be adjusted between positions S1 and S2 according to the speed of vehicle 300. For example, when the speed of vehicle 300 is high, the display distance of the virtual image may be increased, and when the speed of vehicle 300 is low, the display distance of the virtual image may be decreased. At formation of images P1 and P2, an image is imaged when, in either or both of the outward movement and the return movement, screen 130 is located at a position where the display distance of the virtual image corresponds to the distance from vehicle 300 to the pedestrian.

The frequency of vibration of screen 130 is not limited to 60 Hz. The frequency of vibration of screen 130 may be a frequency at which updating of frames by scanning corresponding to the frequency is not recognized as flicker by a human's eyes. For example, when images are updated at a rate of 60 frames per second, motion of moving images can be recognized as smooth by a viewing person. The frequency of vibration may not be constant. For example, the frequency may be temporarily lowered during the movement of vehicle 300. For example, a virtual image based on an image imaged at a lowered frequency appears to be shallow in depth to driver A as compared to a virtual image based on an image imaged on screen 130 moving at a usual frequency. Screen 130 may be stopped temporarily or intermittently. In this case, a virtual image is formed to appear to stand vertically to driver A. For example, each of images P1 and P2 not requiring a sense of depth may be displayed as such a virtual image.

When display device 10 is used as a vehicle HUD as in the present exemplary embodiment, external light such as sunlight may enter and travel backward in overall optical path L. Specifically, the external light may pass through windshield 201 and enter the interior of the vehicle, and then reflect on optical system 160 and reach screen 130 and self-emitting display unit 140. The external light illuminates entire screen 130 and self-emitting display unit 140 to reduce a difference in brightness of light between screen 130 and self-emitting display unit 140, thereby degrading contrast of a virtual image. In a case where the external light is sunlight in particular, infrared rays may raise the internal temperature of display device 10 and ultraviolet rays may deteriorate components of screen 130, self-emitting display unit 140, and others. To avoid these problems, optical system 160 may be at least partially coated such that optical system 160 transmits only light with a specific wavelength as a whole. Use of a laser light source with a narrow wavelength spectral width of light as light source unit 110 in combination with optical system 160 allows optical system 160 to transmit more efficiently ultraviolet light, infrared light, and yellow light unnecessary for displaying a virtual image.

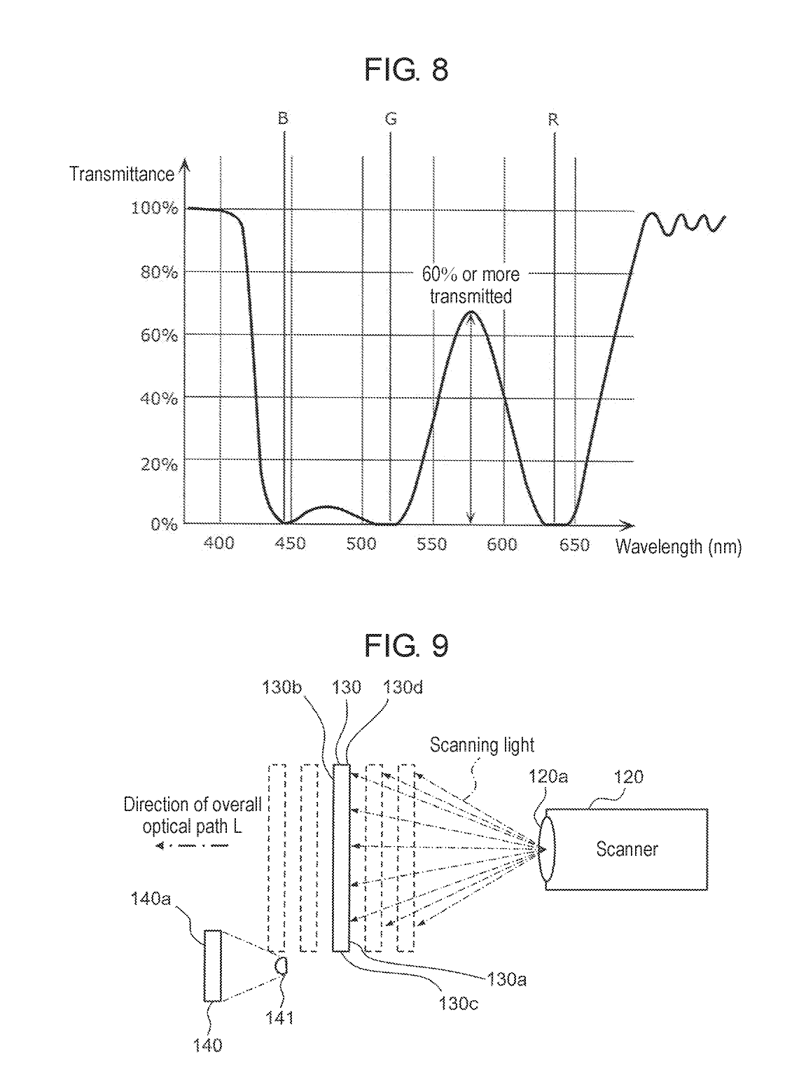

For example, reflecting mirrors 160a and 160b such as concave mirrors constituting optical system 160 may have light transmission characteristics as illustrated in FIG. 8. FIG. 8 is a diagram illustrating an example of light transmission characteristics of a reflecting mirror applied to optical system 160 in display device 10 according to the exemplary embodiment. Referring to FIG. 8, the reflecting mirror has an optical characteristic of transmitting almost all ultraviolet light (with a wavelength of 410 nm or less) and infrared light (with a wavelength of 700 nm or more). Optical system 160 transmits ultraviolet light and infrared light, and the ultraviolet light and the infrared light do not reach screen 130 and self-emitting display unit 140. This makes it possible to suppress temperature rise and deterioration of components due to influence of infrared light and others in display device 10. On the other hand, the reflecting mirror reflects visible light of almost all wavelengths between ultraviolet light and infrared light. In particular, the reflecting mirror reflects almost 100% of light in the wavelengths of three primary colors emitted from light source unit 110, that is, light in and around the wavelengths of R, G, and B illustrated in FIG. 8. That is, the maximum part of the light having passed from light source unit 110 through screen 130 travels along overall optical path L and reaches windshield 201. Use of optical system 160 including the reflecting mirror with such light transmission characteristics makes it possible to prevent a reduction in contrast of a virtual image due to influence of the external light even when display device 10 is used as a vehicle HUD. As illustrated in FIG. 8, the reflecting mirror transmits up to 60% or more of the yellow light and light in the wavelength spectrum (550 to 600 nm) near the yellow light. The foregoing light is unnecessary for displaying a virtual image because it decreases a difference in brightness of light on display medium 200, and reduction of the light suppresses a reduction in the contrast of a virtual image as much as possible.

As a specific example, the foregoing characteristics may be imparted to at least one of reflecting mirrors 160a and 160b illustrated in FIG. 5 by applying a coat or the like. When optical system 160 includes a plurality of mirrors such as reflecting mirrors, functions may be distributed among the plurality of mirrors such as causing a first mirror to transmit infrared light and ultraviolet light and causing a second mirror to transmit visible light unnecessary for displaying a virtual image, for example. The unnecessary light having passed through the mirror is changed to heat in a mirror holder not illustrated. When functions are distributed among the plurality of mirrors, the heat is absorbed in a plurality of separated places. In this case, therefore, it is possible to obtain an effect of suppressing a temperature rise in the various places as compared to a case in which the heat is absorbed only in one place.

Also in this case, the first mirror preferably has a larger area than the second mirror. A mirror to transmit visible light is produced using a dielectric multi-layer film, for example, so that it takes a higher manufacturing cost. Therefore, use of the second mirror smaller in area makes it possible to obtain an effect of suppressing the manufacturing cost. In addition, a mirror to transmit infrared light and ultraviolet light has a larger heat absorption amount, and thus transmission of infrared light and ultraviolet light through the mirror larger in area makes it possible to obtain an effect of suppressing a temperature rise.

### 2. Operations of the Display Device According to Exemplary Embodiment

Operations of display device 10 will be described with reference to FIGS. 3 to 7. Based on information input from an external device, controller 100 of display device 10 transmits to light source unit 110 a control signal for emitting light for generating an image to be projected onto region D1 of windshield 201, and transmits to self-emitting display unit 140 a control signal for generating an image to be projected onto region D1 of windshield 201. Controller 100 also transmits to scan unit 120 a control signal for scanning screen 130 to image a projected image in region D1 on screen 130, and transmits to drive unit 150 a control signal for operating screen 130 to keep a display distance necessary for a virtual image of the projected image in region D1. A first image imaged on screen 130 by scanning light of scan unit 120 and a second image generated by self-emitting display unit 140 are projected onto optical system 160, and optical system 160 projects projected first image and second image onto respective regions D1 and D2 of windshield 201. The projected first image and second image are reflected on windshield 201 and travel toward driver A, and then are visually recognized by driver A. Driver A recognizes the second image in region D2 as a virtual image approximately vertically standing in front of driver A, and recognizes the first image in region D1 as a three-dimensional virtual image that is positioned more distant than the second image in front of driver A and has a depth.

In the present exemplary embodiment, display device 10 constantly displays in region D2 information about the conditions of a vehicle not relating to the travel of vehicle 300, changes in the foreground through windshield 201, and others. Display device 10 keeps the display distance of the virtual image in region D2 visually recognized by driver A constant. Driver A can visually recognize the virtual image of the vehicle information displayed in region D2 at the same distance all the time and can easily adjust the focus of the eyes, so that it is possible to suppress false recognition of the vehicle information. Display device 10 temporarily displays in region D1 information varying along with the travel of vehicle 300 and changes in the foreground through windshield 201 as necessary. Display device 10 changes the display distance of the virtual image in region D1 visually recognized by driver A according to a distance from driver A to a target providing the information, for example. Further, display device 10 changes the display distance of the virtual image in region D1 visually recognized by driver A according to a speed of vehicle 300. Accordingly, driver A can visually recognize the virtual image of the information displayed in region D1 in a state of being superimposed on the foreground through windshield 201. Driver A can visually recognize nearby the vehicle information constantly displayed in region D2, so that it is possible to suppress false recognition of the vehicle information.

### 3. Advantageous Effects

Display device 10 according to the exemplary embodiment of the present disclosure displays a virtual image by projecting an image onto display medium 200. Display device 10 includes light source unit 110 that emits light; screen 130 that is movably disposed on an optical path from light source unit 110 to display medium 200; self-emitting display unit 140 that is disposed adjacent to the optical path; scan unit 120 that scans screen 130 with the light emitted from light source unit 110; and drive unit 150 that moves screen 130 along the optical path. Screen 130 is disposed to project an image imaged on screen 130 by scanning of scan unit 120 onto display medium 200, and self-emitting display unit 140 is disposed to project an image generated by self-emitting display unit 140 onto display medium 200.

In the foregoing configuration, two images projected from screen 130 and self-emitting display unit 140 onto display medium 200 are reflected on display medium 200 and arrive at the eyes of a person viewing display medium 200. At this time, the person visually recognizes two virtual images of the two images on an opposite side of display medium 200. Each of the display distances of the two virtual images depends on a distance along an optical path from display medium 200 to screen 130 and a distance along an optical path from display medium 200 to self-emitting display unit 140. Screen 130 and self-emitting display unit 140 do not affect quality of images generated by screen 130 and self-emitting display unit 140. Accordingly, it is possible to obtain two clear virtual images by positioning screen 130 and self-emitting display unit 140 so as to match respective display distances required for the two virtual images. Scan unit 120 does not need to scan self-emitting display unit 140 but needs to scan only screen 130, so that it is possible to shallow a focal depth of a light beam emitted from scan unit 120. Accordingly, a spot diameter of the light on screen 130 becomes small, so that it is possible to improve the resolution of the virtual image.

In display device 10 according to the exemplary embodiment, screen 130 and self-emitting display unit 140 are disposed to partially overlap each other as seen from a direction along the optical path. In the foregoing configuration, it is possible to reduce a gap between the image projected from screen 130 and the image projected from self-emitting display unit 140. This reduces leakage of the scanning light of scan unit 120 through the gap.

In display device 10 according to the exemplary embodiment, scan unit 120 is disposed such that the spot diameter becomes minimum at an almost center position in a movement range of screen 130. In the foregoing configuration, a maximum spot diameter in the movement range of screen 130 can be decreased, so that the spot diameter of the light on screen 130 becomes small, and accordingly, the resolution of the image is enhanced. This achieves improvement in the resolution of the virtual image.

In display device 10 according to the exemplary embodiment, an image projected from screen 130 onto display medium 200 and an image projected from self-emitting display unit 140 onto display medium 200 are adjacent to each other. In the foregoing configuration, it is possible to decrease eye movement for visually recognizing a virtual image of the image projected from screen 130 and a virtual image of the image projected from self-emitting display unit 140. This makes it easy to visually recognize the two virtual images.

Display device 10 according to the exemplary embodiment further includes optical system 160 that is disposed on the optical path between screen 130 and display medium 200. Optical system 160 projects the image projected from screen 130 onto display medium 200 in a changed projection direction. According to the foregoing configuration, it is possible to increase the display distance of the virtual image corresponding to the distance from display medium 200 to screen 130 along the optical path while suppressing upsizing of display device 10.

Display device 10 according to the exemplary embodiment is mounted on vehicle 300 as a movable body. An image formed on screen 130 is an image temporarily displayed along with travel of vehicle 300, and an image generated by self-emitting display unit 140 is an image continuously displayed. In the foregoing configuration, a display distance of a virtual image of the image continuously generated by self-emitting display unit 140 remains unchanged, which facilitates adjustment of eye focus for visually recognizing the virtual image continuously displayed, thereby making it easy to visually recognize the virtual image. A virtual image of the image imaged on movable screen 130 can be three-dimensionally represented with depth, for example. This makes it possible to form and display a three-dimensional virtual image along with the travel of the movable body. Such a virtual image is suitable for superimposing on the foreground in a traveling direction of the movable body.

### 4. Others

The display device according to the exemplary embodiment has been described as an example of a technique disclosed in the present application. However, the present disclosure is not limited to the exemplary embodiment. The technique in the present disclosure is also applicable to modifications of the exemplary embodiment in which change, replacement, addition, or omission is made as appropriate, or other exemplary embodiments. In addition, new exemplary embodiments or modifications can be made by combining constituent elements in the exemplary embodiment.

As described above, the comprehensive or specific aspects of the present disclosure may be implemented by a system, a method, an integrated circuit, a computer program, or a recording medium such as a computer-readable CD-ROM. Moreover, the comprehensive or specific aspects of the present disclosure may be implemented by any combination of a system, a method, an integrated circuit, a computer program, and a recording medium.

For example, processing units included in the display devices according to the exemplary embodiment described above are typically implemented as large-scale integration (LSI) circuits. Each of the circuits may be integrated into one chip, or some or all of the circuits may be integrated into one chip.

The circuit integration is not limited to the LSI, and may be achieved by a dedicated circuit or a general-purpose processor. There may be used: a field programmable gate array (FPGA) programmable after the LSI is fabricated; or a reconfigurable processor in which connections and settings of circuit cells in the LSI are reconfigurable.

In the above exemplary embodiments, the constituents may be implemented by dedicated hardware or by execution of software programs individually suitable for the constituents. The constituent elements may be implemented by a program execution section, such as a CPU or a processor, reading and executing software programs stored in a recording medium, such as a hard disk or a semiconductor memory.

The division of the functional block in the block diagram is only by way of example, and a plurality of functional blocks may be implemented as one functional block, one functional block may be divided into a plurality of functional blocks, or a part of the functions may be transferred to another functional block. Functions of a plurality of functional blocks having similar functions may be processed in parallel or in a time division manner by single piece of hardware or software.

In display device 10 according to the exemplary embodiment, self-emitting display unit 140 is disposed between first reflecting mirror 160a and screen 130, but the present disclosure is not limited to this. For example, self-emitting display unit 140 may be disposed between first reflecting mirror 160a and second reflecting mirror 160b to display an image to second reflecting mirror 160b. Alternatively, self-emitting display unit 140 may be disposed between display medium 200 and first reflecting mirror 160a to display an image to display medium 200. These configurations make it possible to shorten the distance between self-emitting display unit 140 and display medium 200 and reduce the display distance of the virtual image in region D2. That is, driver A can visually recognize nearby the virtual image in region D2. For example, when the display distance required for the virtual image in region D2 is longer than the display distance required for the virtual image in region D1, shortening the distance between self-emitting display unit 140 and display medium 200 as described above is effective.

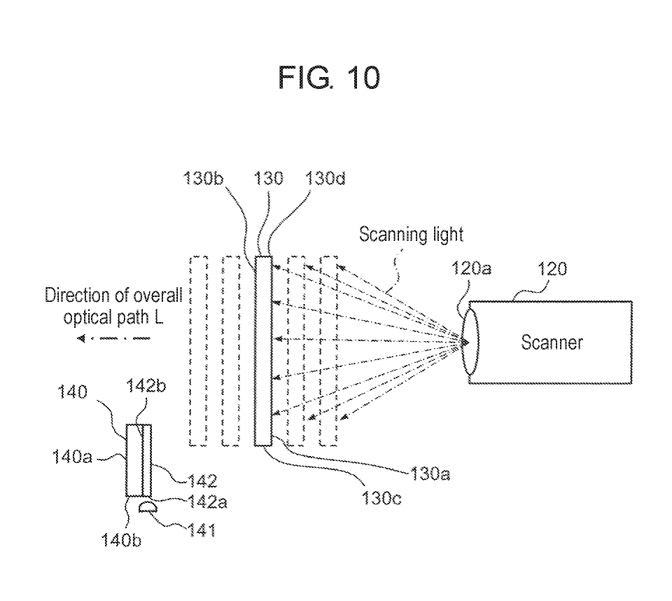

In display device 10 according to the exemplary embodiment, when self-emitting display unit 140 is an LCD, light source 141 may be provided as a backlight for irradiating self-emitting display unit 140 with light on the side opposite to display surface 140a as illustrated in FIG. 9. Alternatively, when self-emitting display unit 140 is an LCD, self-emitting display unit 140 may include light-guiding member 142 in a rectangular plate shape on the surface opposite to display surface 140a, and self-emitting display unit 140 may further include light source 141 that projects light onto peripheral edge 142a of light-guiding member 142 as illustrated in FIG. 10. Light source 141 may be a white light emitting diode (LED), for example. A shape of light-guiding member 142 may be any shape.

In self-emitting display unit 140 illustrated in FIG. 10, light source 141 projects light from peripheral edge 142a to inside of light-guiding member 142. Light-guiding member 142 emits the light incident from peripheral edge 142a from surface 142b opposed to self-emitting display unit 140, and irradiates self-emitting display unit 140 with the light. Light-guiding member 142 may be a diffusing light-guiding member that diffuses and emits from surface 142b the light incident from peripheral edge 142a, for example. The diffusing light-guiding member may include therein a plurality of diffusing particles, or may have a plurality of recesses and projections on surface 142b, or may have a plurality of dots printed on surface 142b. Self-emitting display unit 140 including light source 141 and light-guiding member 142 as described above enables more reduction in an occupied space on a rear side of display surface 140a than a self-emitting display unit including only light source 141 immediately below. This suppresses interference between constituent elements on the rear side of self-emitting display unit 140 and screen 130 in motion. Further, it is possible to decrease the distance between self-emitting display unit 140 and screen 130, thereby achieving downsizing of display device 10.

The display device according to one aspect has been described above based on the exemplary embodiment, but the present disclosure is not limited to the exemplary embodiment. Configurations in which various variations conceived by those skilled in the art are applied to the present exemplary embodiment, and configurations constructed by combining the constituent element in different exemplary embodiments may also fall within the scope of one aspect without departing from the spirit of the present disclosure.

### INDUSTRIAL APPLICABILITY

The present disclosure can be applied to a display device that displays a virtual image by using a display medium.

### REFERENCE MARKS IN THE DRAWINGS

10 display device
100 controller
110 light source unit
120 scan unit
120a lens
130 screen
130a first main surface
130b second main surface
130c edge
130d edge
140 self-emitting display unit
140a display surface
141 light source
142 light-guiding member
142a peripheral edge
142b surface
150 drive unit
160 optical system
160a first reflecting mirror
160b second reflecting mirror
200 display medium
201 windshield
300 vehicle (movable body)
301 dashboard

1. A display device that displays a virtual image by projecting an image onto a display medium, the device comprising:
a light source that emits light;
a screen that is movably disposed on an optical path from the light source to the display medium;
a self-emitting display that is disposed adjacent to the optical path;
a scanner that scans the screen with the light emitted from the light source; and
a driver that moves the screen along the optical path,
wherein
the screen is disposed to project, onto the display medium, an image imaged on the screen by scanning of the scanner, and
the self-emitting display is disposed to project an image generated by the self-emitting display onto the display medium.

2. The display device according to claim 1, wherein the screen and the self-emitting display are disposed to partially overlap each other as seen from a direction along the optical path.

3. The display device according to claim 1, wherein the scanner is disposed such that a spot diameter of the light emitted from the scanner becomes minimum at a substantially center position in a movement range of the screen.

4. The display device according to claim 1, wherein an image projected from the screen onto the display medium and an image projected from the self-emitting display onto the display medium are adjacent to each other.

5. The display device according to claim 1, further comprising an optical system that is disposed on the optical path between the screen and the display medium, wherein
the optical system projects the image projected from the screen onto the display medium in a changed projection direction.

6. The display device according to claim 1, wherein
the display device is mounted on a movable body,
an image imaged on the screen is an image temporarily displayed along with travel of the movable body, and
an image generated by the self-emitting display is an image continuously displayed.

7. The display device according to claim 1, wherein
the self-emitting display is a flat panel display, and
the self-emitting display has a light-guiding member that is disposed on a side opposite to a display surface of an image and a light source that projects light onto an edge of the light-guiding member.
